(19) United States
(12) Patent Application Publication
(10) Pub. No.: US 2001/0032558 A1
(43) Pub. Date: Oct. 25, 2001

(54) INK FILM THICKNESS CONTROL METHOD AND APPARATUS FOR MULTI-COLOR PRINTING PRESS

(76) Inventor: TATSUO KOMORI, IBARAGI (JP)

Correspondence Address: BLAKELY SOKOLOFF TAYLOR & ZAFMAN, 12400 WILSHIRE BOULEVARD, 7TH FLOOR, LOS ANGELES, CA, 90025

(21) Appl. No.: 09/387,351

(22) Filed: Aug. 31, 1999

(30) Foreign Application Priority Data
Sep. 2, 1998 (JP) 248444/1998

(51) Int. Cl. B41F 5/16; B41F 31/00

(52) U.S. Cl. 101/349.1

(57) ABSTRACT

In an ink film thickness control method for a multi-color printing press having a plurality of printing units for continuously performing designated color printing on a printing paper by means of ink supplied to a printing plate through an ink roller group, when in at least two of the printing units as plate exchange printing units, exchange to new printing plates are simultaneously performed, the number of printing papers to be printed for ink removing is set in units of plate exchange printing units. The ink feed operation in each plate exchange printing unit is turned off. Printing for ink removing is performed in each plate exchange printing unit on the basis of the set number of printing papers while keeping the previous printing plate mounted, thereby forming a first ink film thickness distribution minimum and necessary for printing on the ink roller group of the plate exchange printing unit. An ink film thickness control apparatus is also disclosed.

### BACKGROUND OF THE INVENTION

The present invention relates to an ink film thickness control method and apparatus used in exchanging a printing plate in a multi-color printing press having a plurality of printing units each of which supplies ink in an ink fountain to a printing plate through an ink roller group and print the ink supplied to the printing plate on printing paper.

FIG. 8 shows the main part of an ink supply apparatus in each printing unit (printing section) of a multi-color printing press. Referring to FIG. 8, reference numeral 1 denotes an ink fountain; 2, ink stored in the ink fountain 1; 3, an ink fountain roller; 4, a plurality of ink fountain keys juxtaposed along the axial direction of the ink fountain roller 3; 5, an ink ductor roller; 6, an ink roller group; 6A, ink form rollers in the ink roller group 6; 7, a printing plate; and 8, a plate cylinder.

In the ink supply apparatus having the above arrangement, the ink 2 in the ink fountain 1 is supplied by adjusting the aperture ratios of the ink fountain keys 4. The ink supplied to the ink fountain roller 3 is supplied to the printing plate 7 via the ink roller group 6 by the feed operation of the ink ductor roller 5. Printing paper fed from a paper feed section is printed with the ink supplied to the printing plate 7.

When the printing plate is changed to a new printing plate 7, the aperture ratio of each ink fountain key 4 and the rotation ratio of the ink fountain roller 3 are preset to values corresponding to the image of the printing plate 7. More specifically, the aperture ratio of each ink fountain key 4 and the rotation ratio of the ink fountain roller 3 are set to values corresponding to the image of the printing plate 7, and the ink 2 in the ink fountain 1 is supplied to the new printing plate 7 via the ink roller group 6. In this case, test printing is performed before final printing to adjust the ink supply amount, thereby obtaining a satisfactory color tone. With this operation, a desired ink film thickness distribution (gradient of thickness of the ink film) is formed on the ink roller group 6.

In the conventional ink supply apparatus, however, when the printing plate is exchanged with the new printing plate 7, the ink film thickness distribution for the previous printing plate remains on the ink roller group 6. In this case, the ink film thickness distribution for the previous printing plate must be gradually changed to the ink film thickness distribution for the printing plate 7. This operation excessively requires adjustment of the ink supply amount and test printing until a satisfactory color tone is obtained, resulting in problems including an increase in preparation time for printing, an increase in work load, waste of printing materials, a decrease in production efficiency, and an increase in cost.

The present applicant/assignee has proposed “INK FILM THICKNESS CONTROL METHOD FOR INK SUPPLY APPARATUS” in U.S. Pat. No. 5,884,562 for the purpose of decreasing the number of times of ink supply amount adjustment and test printing until a satisfactory color tone is obtained. In this ink film thickness control method, “ink removing” is performed before exchanging the printing plate with a new printing plate.

This will be described in detail. After final printing using a printing plate, a printing unit is selected on a display (not shown). The “ink removing” mode (function) is selected, and the feed operation of the ink ductor roller 5 is stopped. The printing press is operated while keeping the printing plate mounted, thereby printing a predetermined number of paper sheets. With this operation, a minimum ink film thickness distribution Ma (FIG. 7A; to be referred to as a first ink film thickness distribution hereinafter) necessary for printing is left on the ink roller group 6 such that the ink film thickness decreases from the upstream to the downstream. More specifically, an ink film thickness distribution corresponding to the image of the printing plate is removed from the ink film thickness distribution formed on the ink roller group 6, and the first ink film thickness distribution Ma corresponding to the no-image portion of the printing plate is left.

After the printing plate is changed to a new printing plate 7, the “pre-inking II” function is selected on the display to perform the “pre-inking II” operation. In “pre-inking II”, the aperture ratios of the ink fountain keys 4 and the rotation ratio of the ink fountain roller 3 are preset to values corresponding to the image of the printing plate 7. After this, the printing press is operated. The ink ductor roller 5 is caused to perform the feed operation a predetermined number of times to superpose an ink film thickness distribution Mb (FIG. 7B; to be referred to as a second ink film thickness distribution hereinafter) corresponding to the image of the new printing plate 7 on the first ink film thickness distribution Ma left on the ink roller group 6.

After the second ink film thickness distribution Mb is superposed on the first ink film thickness distribution Ma, a predetermined number of sheets are test-printed. The density of the test-printed matters is checked. If the color tone is satisfactory, ink film thickness control by “ink removing+pre-inking II” is ended, and the operation shifts to final printing. On the other hand, the color tone checked by density check is not satisfactory, the ink film thickness distribution is finely adjusted by “pre-inking (+)” or “pre-inking (−)”, and test-printing is performed again.

In this proposed method, however, when printing plates for the plurality of printing units are simultaneously exchanged, the printing units print the same number of printing papers conveyed from a feed section upon “ink removing” in the respective printing units. At this time, because of ink trapping (a phenomenon wherein ink of early printing is superposed on ink of succeeding printing), the upstream printing units have too little ink while ink in the downstream printing units does not decrease. For this reason, a satisfactory ink film thickness distribution cannot be formed for the subsequent printing operation, and the waste paper increases.

### SUMMARY OF THE INVENTION

It is an object of the present invention to provide an ink film thickness control method and apparatus for a multi-color printing press, which accurately form an ink film thickness distribution for the next printing operation to prevent waste paper.

It is another object of the present invention to provide an ink film thickness control method and apparatus for a multi-color printing press, which can appropriately perform “ink removing” in each of printing units which simultaneously exchange printing plates.

In order to achieve the above objects, according to the present invention, there is provided an ink film thickness control method for a multi-color printing press having a plurality of printing units for continuously performing designated color printing on a printing paper by means of ink supplied to a printing plate through an ink roller group, comprising the steps of when in at least two of the printing units as plate exchange printing units, exchange to new printing plates are simultaneously performed, setting the number of printing papers to be printed for ink removing in units of plate exchange printing units, turning off an ink feed operation in each of the plate exchange printing units, and performing printing for ink removing in each of the plate exchange printing units on the basis of the set number of printing papers while keeping the previous printing plate mounted to form a first ink film thickness distribution minimum and necessary for printing on the ink roller group of the plate exchange printing unit.

### BRIEF DESCRIPTION OF THE DRAWINGS

FIG. 1 is a flow chart showing an ink removing operation (throw-off timing control method) according to the first embodiment of the present invention;

FIG. 2 is a side view showing a four-color rotary printing press to which the present invention is applied;

FIG. 3 is a perspective view showing an operation desk prepared for the printing press shown in FIG. 2;

FIGS. 4A and 4B are plan views, respectively, showing a magnetic card and a floppy disk on which print data is recorded;

FIG. 5 is a block diagram showing the main part of a printing press including an ink film thickness control apparatus;

FIG. 6 is a flow chart showing an ink removing operation (throw-on timing control method) according to the second embodiment of the present invention;

FIGS. 7A and 7B are views respectively showing first and second ink film thickness distributions Ma and Mb formed on an ink roller group; and

FIG. 8 is a view showing the schematic arrangement of an ink supply apparatus in each printing unit of a printing press.

### DESCRIPTION OF THE PREFERRED EMBODIMENTS

The present invention will be described below in detail with reference to the accompanying drawings.

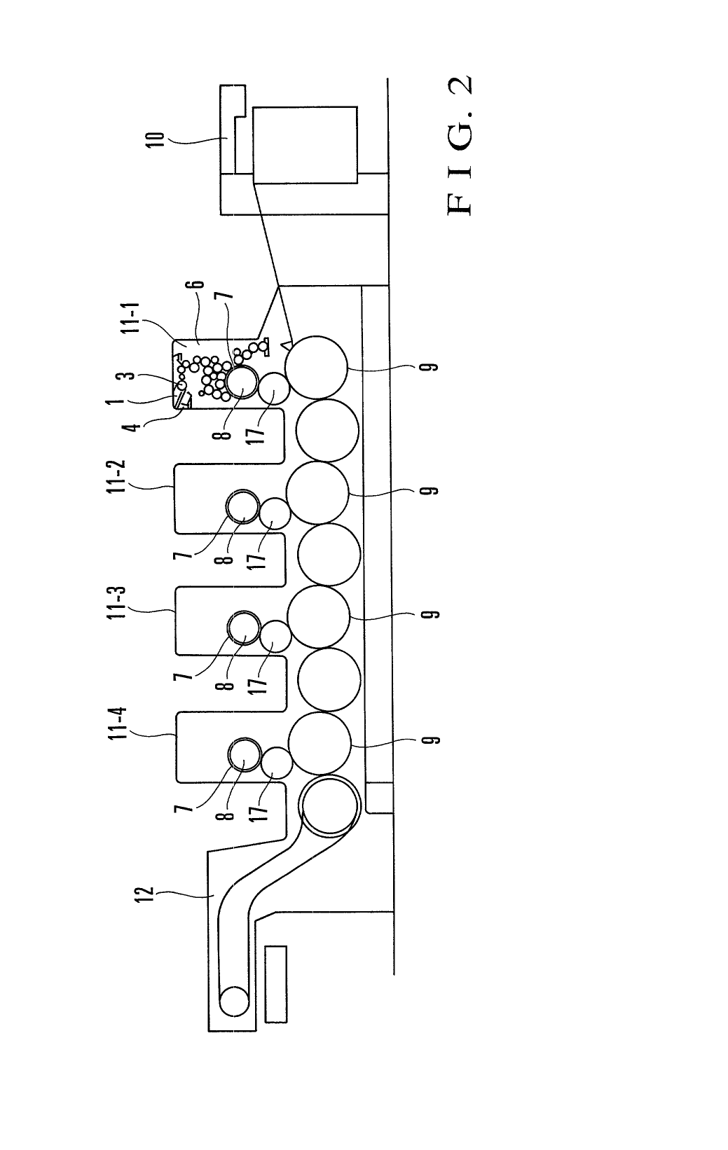

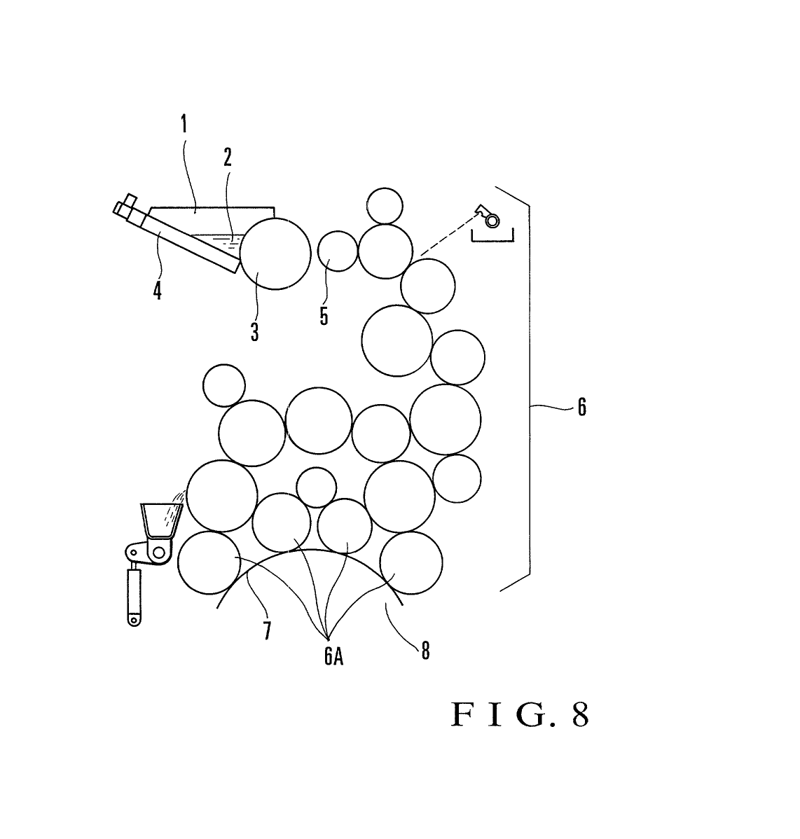

FIG. 2 shows the schematic arrangement of a four-color rotary printing press (four-color printing press) according to the first embodiment of the present invention. Referring to FIG. 2, reference numerals 11-1 to 11-4 denote printing units. Each of the printing units 11-1 to 11-4 has the ink supply apparatus shown in FIG. 8. Reference numeral 9 denotes a blanket cylinder; and 17, an impression cylinder.

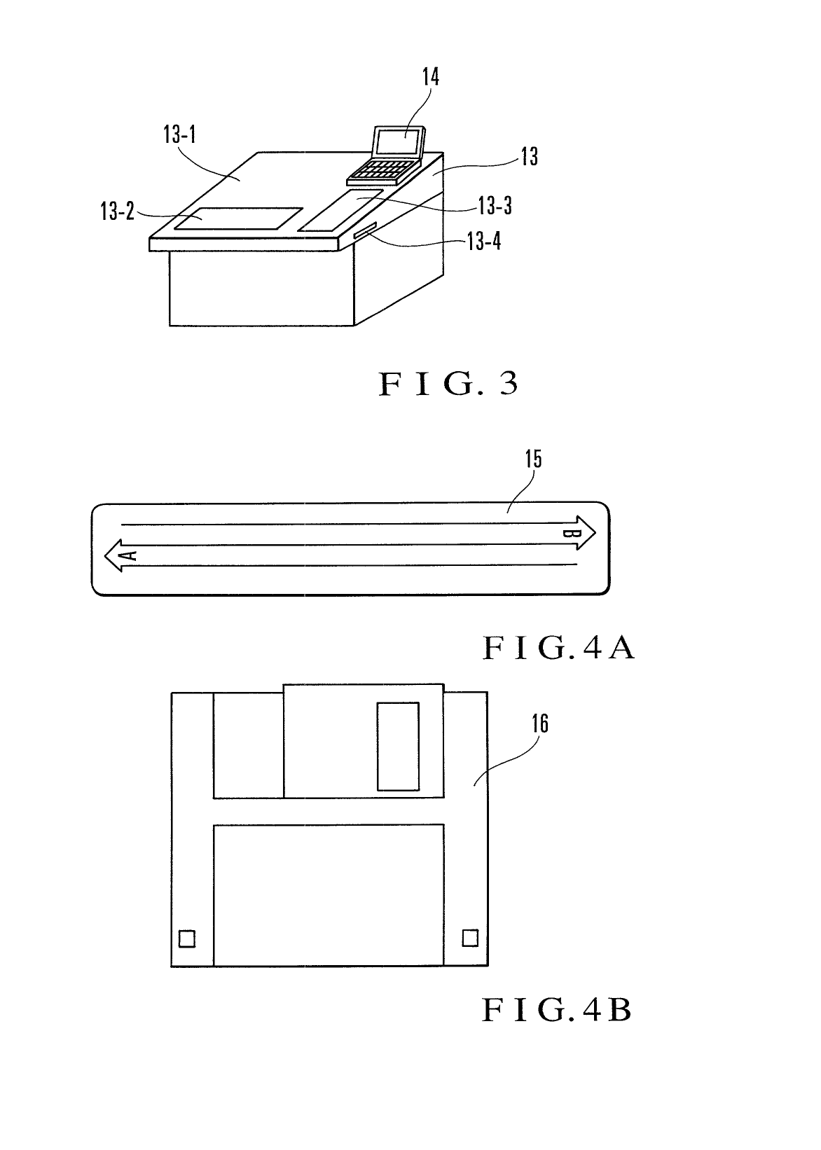

In this four-color printing press, an operation desk 13 as shown in FIG. 3 is near a delivery section 12. The operation desk 13 has an operation panel 13-1 on its upper surface. The operation panel 13-1 has an operation section 13-2 and display section 13-3 on its upper surface. A printing setting unit 14 constructed by a personal computer is mounted on the upper surface of the operation desk 13. The operation desk 13 incorporates a control unit (to be described later). The control apparatus and printing setting unit 14 construct a test printing system.

The operation panel 13-1 has a slot 13-4 for receiving a recording medium such as a magnetic card 15 shown in FIG. 4A or a floppy disk 16 shown in FIG. 4B. Final printing data (print data) prepared on the basis of the image area information of a printing plate is recorded on the recording medium. More specifically, set value data such as a printing unit which uses the printing plate, the aperture ratio of the ink fountain key of the printing unit, and the rotation ratio of the ink fountain roller are recorded as final printing data in units of corresponding printing plates.

In the printing setting unit 14, to form an optimum ink film thickness on each roller of an ink roller group 6, a “pre-inking I”, “ink removing”, “pre-inking II”, “pre-inking (+)”, “pre-inking (−)”, or “test printing” mode (function) is selected on the menu window.

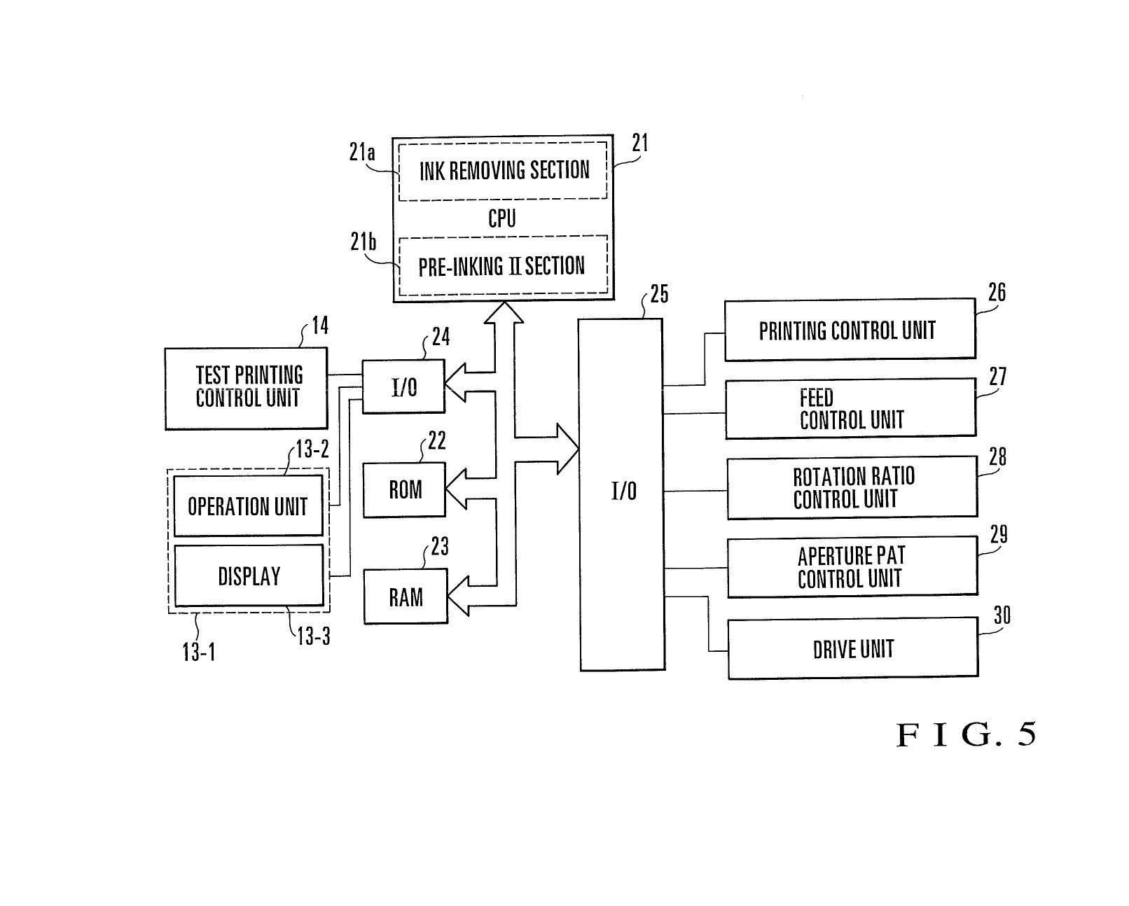

FIG. 5 shows the electrical arrangement of the printing press including the printing setting unit 14. Referring to FIG. 5, reference numeral 21 denotes a CPU (Central Processing Unit) for performing various processing operations; 22, a ROM (Read Only Memory) storing various programs for executing the respective modes; 23, a RAM (Random Access Memory) for storing various data; 24 and 25, I/O interfaces; 26, a printing control unit for controlling printing by the printing press; 27, a feed control unit for ON/OFF-controlling the feed mechanism for feeding ink; 28, a rotation ratio control unit for controlling the rotation ratio of the fountain roller; 29, an aperture ratio control unit for controlling the aperture ratio of an ink key; and 30, a drive unit for driving a recording medium such as a floppy disk.

The I/O interface 24 is connected to the operation section 13-2, display section 13-3, and printing setting unit 14. The I/O interface 25 is connected to the printing control unit 26, feed control unit 27, rotation ratio control unit 28, aperture ratio control unit 29, and drive unit 30. The printing control unit 26, feed control unit 27, rotation ratio control unit 28, and aperture ratio control unit 29 are prepared for each of the printing units 11-1 to 11-4. When a magnetic card is used as a recording medium, a card read unit is connected to the I/O interface 25 in place of the drive unit 30.

Upon receiving various input information, the CPU 21 accesses the RAM 23 to perform various processing operations in accordance with the programs stored in the ROM 22. The CPU 21 has an ink removing section 21a and pre-inking II section 21b as means for performing various processing operations. Pieces of input information to the CPU 21 are supplied to the display section 13-3, printing setting unit 14, printing control unit 26, feed control unit 27, rotation ratio control unit 28, aperture ratio control unit 29, and drive unit 30 through the I/O interfaces 24 and 25.

The printing setting unit 14 selects one of the “pre-inking I”, “ink removing”, “pre-inking II”, “pre-inking (+)”, “pre-inking (−)”, or “test printing” modes (functions) to form an optimum ink film thickness on each roller of the ink roller group 6.

In the “pre-inking I” mode, after a first ink film thickness distribution Ma is formed, a second ink film thickness distribution Mb is further formed on the first ink film thickness distribution Ma. In the “ink removing” mode, the first ink film thickness distribution Ma is formed by removing the second ink film thickness distribution Mb. In the “pre-inking II” mode, the second ink film thickness distribution Mb is formed on the first ink film thickness distribution Ma which has already been formed. In the “pre-inking (+)” and “pre-inking (−)” modes, the second ink film thickness distribution Mb is increased and decreased.

The operation panel 13-1 has the slot 13-4 for receiving a recording medium such as the magnetic card 15 shown in FIG. 4B or floppy disk 16 shown in FIG. 4B. In this embodiment, a recording medium on which final printing data (print data) prepared on the basis of the image area information of a printing plate is recorded is set in the slot 13-1. More specifically, set value data such as a printing unit which uses the printing plate, the aperture ratio of the ink fountain key of the printing unit, and the rotation ratio of the ink fountain roller are recorded on the recording medium as final printing data. The recording medium may be set in the printing setting unit 14 such that the printing setting unit 14 can load the final printing data.

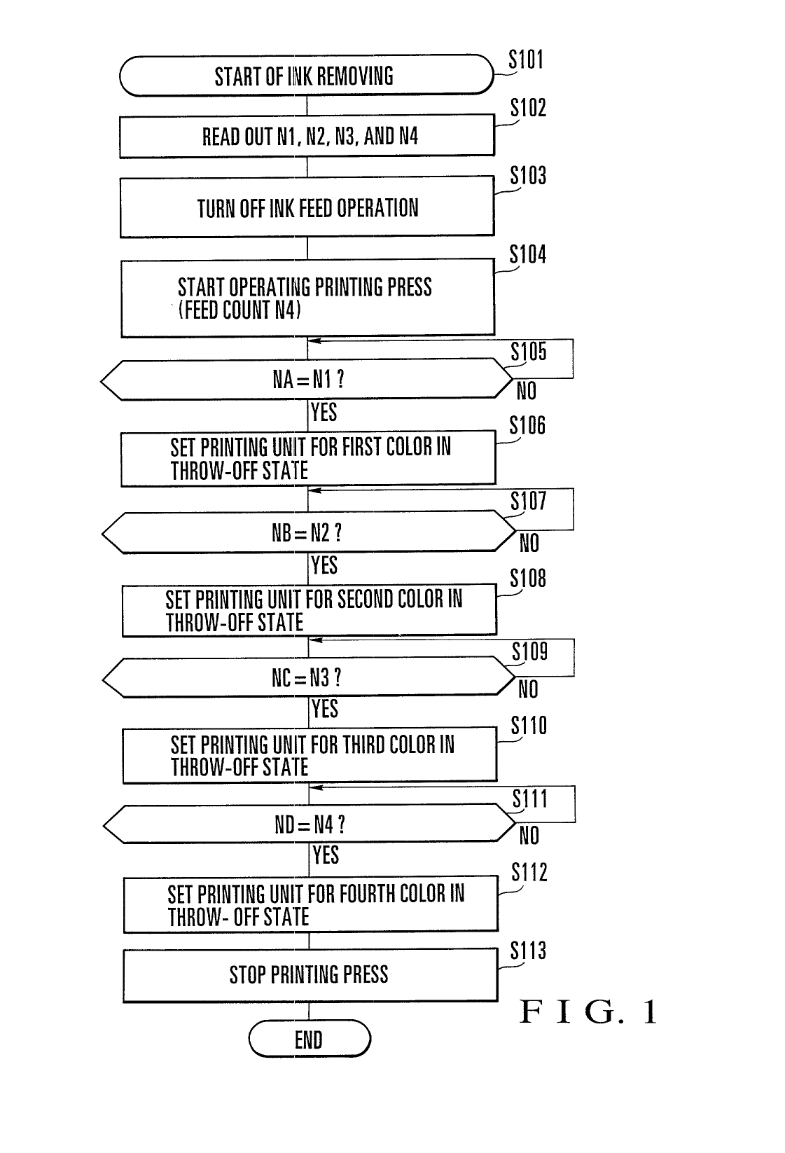

An operation of forming an ink film thickness distribution on the ink roller group 6 when the printing units 11-1 to 11-4 of the four-color printing press with the above arrangement simultaneously exchange the printing plates 7 will be described with reference to FIG. 1.

When the printing setting unit 14 is powered on, a menu window appears on the display. The menu window displays “pre-inking I”, “ink removing”, “pre-inking II”, “pre-inking (+)”, “pre-inking (−)”, and “test printing” as selectable modes. Numbers “1” to “4” corresponding to the printing units 11-1 to 11-4, respectively, are also displayed.

A case wherein after the end of final printing, four printing plates in the printing units 11-1 to 11-4 are simultaneously changed to new printing plates 7 will be described. In this case, the operator sets in advance, in the menu window on the printing setting unit 14, the number of printing papers (removing count) for “ink removing” in units of printing units 11-1 to 11-4 in consideration of ink trapping.

More specifically, for “ink removing” in one printing unit, the removing count takes a predetermined theoretical value N (the value N changes depending on factors such as ink and blanket). However, when “ink removing” is to be performed simultaneously in a plurality of printing units, the removing count changes in units of printing units due to the difference in ink trapping.

When the printing plates are simultaneously changed to new printing plates 7-1 to 7-4, values N1, N2, N3, and N4 (N4>N3>N2>N1) are set as removing counts for the printing units 11-1, 11-2, 11-3, and 11-4, respectively, in consideration of ink trapping. The removing counts N1, N2, N3, and N4 are stored in the RAM 23.

Immediately after final printing, the operator sets a recording medium such as the magnetic card 15 or floppy disk 16 having print data of the new printing plates 7-1 to 7-4 in the slot 13-4 of the operation panel 13-1, thereby inputting new print data. The input print data of the new printing plates 7-1 to 7-4 are transferred to the CPU 21 through the interface 24 and stored in the RAM 23.

<Ink Removing (Throw-off Timing Control Method)>

“Ink removing” processing is executed by the ink removing section 21a of the CPU 21. This will be described below as processing of the CPU 21.

The operator selects the numbers “1” to “4” corresponding to the printing units 11-1 to 11-4, respectively, in the menu window on the printing setting unit 14, and selects “ink removing”. That is, the operator instructs the printing units 11-1 to 11-4 to start “ink removing” (step S101).

At this time, on the ink roller group 6 of each of the printing units 11-1 to 11-4, the second ink film thickness distribution Mb corresponding to the image of the previous printing plate remains while being superposed on the first ink film thickness distribution Ma by the immediately preceding printing operation.

When start of “ink removing” is instructed, the CPU 21 reads out the removing counts N1, N2, N3, and N4 from the RAM 23 (step S102). The CPU 21 and printing control unit 26 turn off the feed operation of ink ductor rollers 5 of the printing units 11-1 to 11-4. After this, the feed count is set to N4, and the printing press is operated while keeping the previous printing plates mounted (steps S103 and S104). In this case, the printing units 11-1 to 11-4 are in the throw-on state.

The printing units 11-1 to 11-4 print printing papers conveyed from a feed section 10. In each of the printing units 11-1 to 11-4, printing is performed while keeping the feed operation of the ink ductor roller 5 stopped, so ink 2 in each of the printing units 11-1 to 11-4 is not supplied to the ink roller group 6.

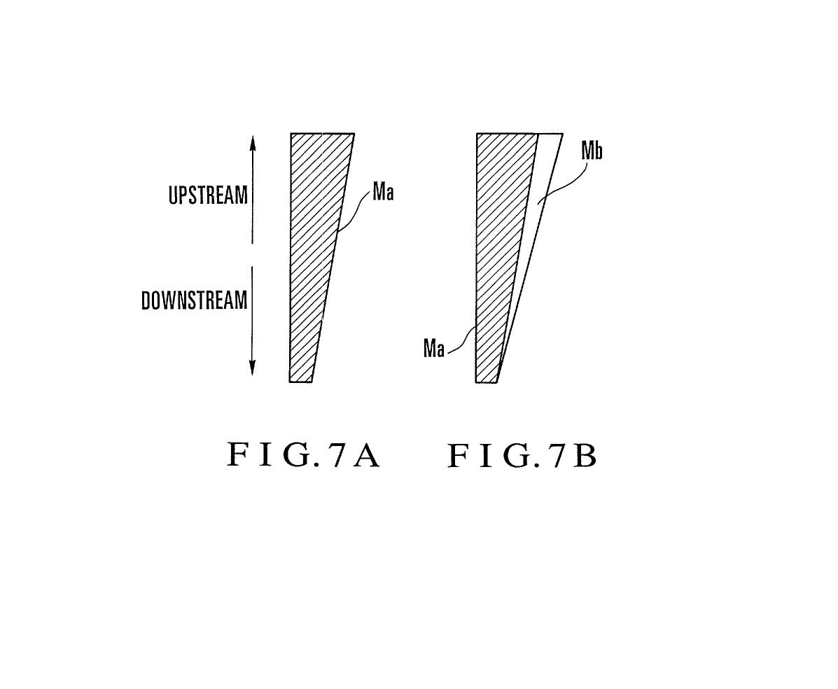

When a print count NA in the printing unit 11-1 reaches N1 (step S105), the CPU 21 issues a throw-off instruction to the printing unit 11-1 (step S106). The printing unit 11-1 is set in the throw-off state. Printing by the printing unit 11-1 is interrupted. After this, printing papers that have passed through the printing unit 11-1 without being printed are sent to the printing unit 11-2. At this time, of the ink held by the ink roller group 6 of the printing unit 11-1, only the second ink film thickness distribution Mb is consumed by printing for the print count N1. Consequently, the history of ink in the ink roller group 6 is canceled, and the first ink film thickness distribution Ma (FIG. 7A) common to the previous and new printing plates is left in an appropriate amount.

When a print count NB in the printing unit 11-2 reaches N2 (step S107), the CPU 21 issues a throw-off instruction to the printing unit 11-2 (step S108). The printing unit 11-2 is set in the throw-off state. Printing by the printing unit 11-2 is interrupted. After this, printing papers that have passed through the printing units 11-1 and 11-2 without being printed are sent to the printing unit 11-3. At this time, of the ink held by the ink roller group 6 of the printing unit 11-2, only the second ink film thickness distribution Mb is consumed by printing for the print count N2. Consequently, the history of ink in the ink roller group 6 is canceled, and the first ink film thickness distribution Ma is left in an appropriate amount.

When a print count NC in the printing unit 11-3 reaches N3 (step S109), the CPU 21 issues a throw-off instruction to the printing unit 11-3 (step S110). The printing unit 11-3 is set in the throw-off state. Printing by the printing unit 11-3 is interrupted. After this, printing papers that have passed through the printing units 11-1, 11-2, and 11-3 without being printed are sent to the printing unit 11-4. At this time, of the ink held by the ink roller group 6 of the printing unit 11-3, only the second ink film thickness distribution Mb is consumed by printing for the print count N3. Consequently, the history of ink in the ink roller group 6 is canceled, and the first ink film thickness distribution Ma is left in an appropriate amount.

When a print count ND in the printing unit 11-4 reaches N4 (step S111), the CPU 21 issues a throw-off instruction to the printing unit 11-4 (step S112). The printing unit 11-4 is set in the throw-off state. Printing by the printing unit 11-4 is interrupted. At this time, of the ink held by the ink roller group 6 of the printing unit 11-4, only the second ink film thickness distribution Mb is consumed by printing for the print count N4. Consequently, the history of ink in the ink roller group 6 is canceled, and the first ink film thickness distribution Ma is left in an appropriate amount. After this, the CPU 21 stops operating the printing press (step S113).

In the above description, throw-on means that the plate cylinder 8, blanket cylinder 9, and impression cylinder 17 shown in FIG. 2 are set in the throw-on state (contact state) to start printing. Throw-off means that the plate cylinder 8, blanket cylinder 9, and impression cylinder 17 shown in FIG. 2 are set in the throw-off state (separated state) to stop printing.

<Pre-Inking II>

“Pre-inking II” processing is executed by the pre-inking II section 21b of the CPU 21. This will be described below as processing of the CPU 21.

When “ink removing” is ended, and the printing plates are exchanged with the new printing plates 7, the operator selects the numbers “1” to “4” corresponding to the printing units 11-1 to 11-4, respectively, in the menu window on the printing setting unit 14, and selects “pre-inking II”. That is, the operator instructs the printing units 11-1 to 11-4 to start “pre-inking II”.

In this “pre-inking II”, the CPU 21 presets the aperture ratios of the ink fountain keys 4 and the rotation ratios of the ink fountain rollers 3 in the printing units 11-1 to 11-4 to values corresponding to the images of the new printing plates 7 and operates the printing press. In each of the printing units 11-1 to 11-4, the ink ductor roller 5 is caused to perform the feed operation a predetermined number of times to superpose the second ink film thickness distribution Mb on the first ink film thickness distribution Ma left on the ink roller group 6.

In this case, since the first ink film thickness distribution Ma is left on the ink roller group 6 of each of the printing units 11-1 to 11-4 in an appropriately amount by “ink removing”, the second ink film thickness distribution Mb for the next printing operation is accurately formed by “pre-inking II”, and waste paper can be suppressed.

The second embodiment of the present invention will be described next. <Ink Removing (Throw-On Timing Control Method)>In the first embodiment, in “ink removing”, the printing units 11-1 to 11-4 are simultaneously set in the throw-on state, and then, the throw-off timing is controlled in units of printing units 11-1 to 11-4. However, the printing units may be simultaneously set in the throw-off state after the throw-on timing is controlled in units of printing units.

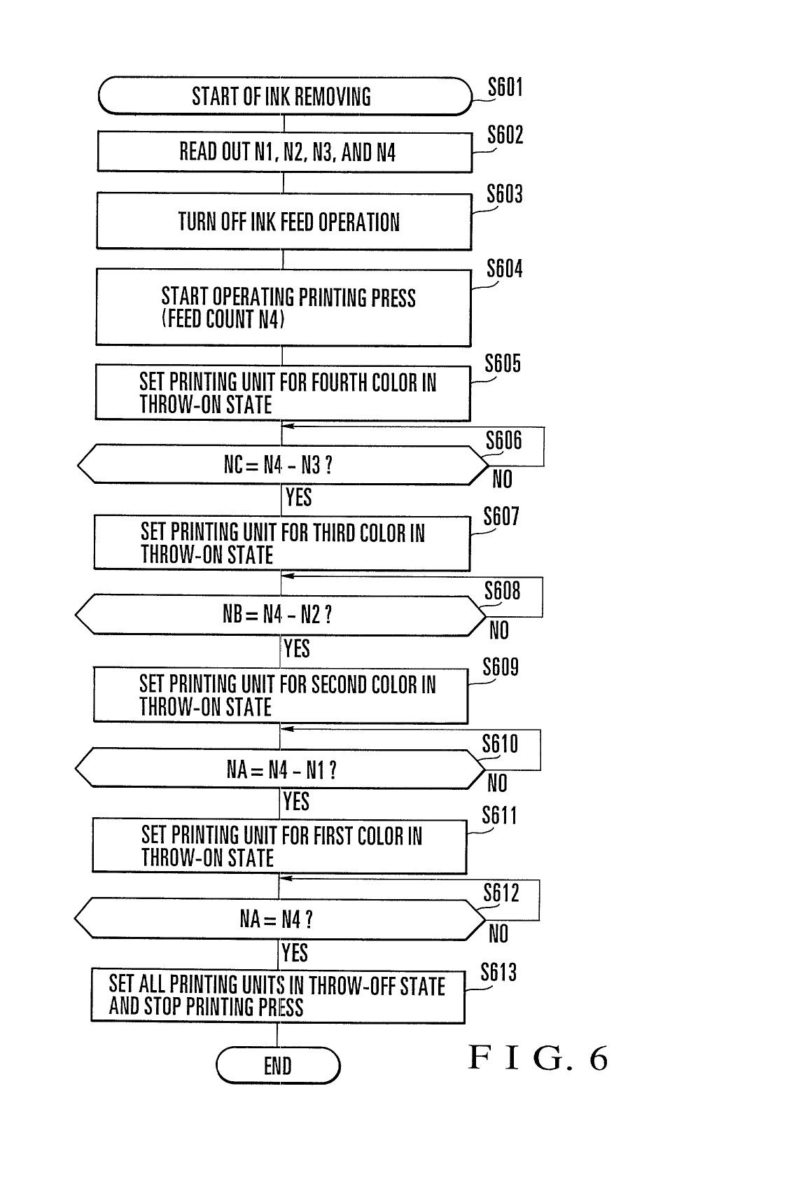

A case wherein the throw-on timing is controlled will be described below with reference to FIG. 6.

The operator selects the numbers “1” to “4” corresponding to printing units 11-1 to 11-4, respectively, in the menu window on a printing setting unit 14, and selects “ink removing”. That is, the operator instructs the printing units 11-1 to 11-4 to start “ink removing” (step S601).

At this time, on an ink roller group 6 of each of the printing units 11-1 to 11-4, a second ink film thickness distribution Mb corresponding to the image of the previous printing plate is superposed on a first ink film thickness distribution Ma.

When start of “ink removing” is instructed, a CPU 21 reads out removing counts N1, N2, N3, and N4 from a RAM 23 (step S602). The CPU 21 turns off the feed operation of ink ductor rollers 5 of the printing units 11-1 to 11-4. After this, the feed count is set to N4, and the printing press is operated while keeping the previous printing plates mounted (steps S603 and S604). In this case, the printing units 11-1 to 11-4 are in the throw-off state.

After the start of operation of the printing press, the CPU 21 issues a throw-on instruction to the printing unit 11-4 (step S605). The printing units 11-1 to 11-3 are set in the throw-off state, and the printing unit 11-4 is in the throw-on state. The printing unit 11-4 starts printing papers that have passed through the printing units 11-1 to 11-3 without being printed.

When a pass count NC of printing papers in the printing unit 11-3 reaches N4−N3 (step S606), the CPU 21 issues a throw-on instruction to the printing unit 11-3 (step S607). The printing unit 11-3 is set in the throw-on state and starts printing papers that have passed through the printing units 11-1 and 11-2 without being printed.

When a pass count NB of printing papers in the printing unit 11-2 reaches N4−N2 (step S608), the CPU 21 issues a throw-on instruction to the printing unit 11-2 (step S609). The printing unit 11-2 is set in the throw-on state and starts printing papers that have passed through the printing unit 11-1 without being printed.

When a pass count NA of printing papers in the printing unit 11-1 reaches N4−N1 (step S610), the CPU 21 issues a throw-on instruction to the printing unit 11-1 (step S611). The printing unit 11-1 is set in the throw-on state and starts printing papers sent from a feed section 10.

When the print count NA in the printing unit 11-4 reaches “N4” (step S612), the CPU 21 issues a throw-off instruction to the printing units 11-1 to 11-4 and stops operating the printing press (step S613).

In the printing unit 11-1, the “(N4−N1)+1”th to “N4”th printing papers, i.e., N1 printing papers are printed while keeping the feed operation of the ink ductor roller 5 stopped. As a result, the history of ink in the ink roller group 6 is canceled, and the first ink film thickness distribution Ma is left in an appropriate amount.

In the printing unit 11-2, the “(N4−N2)+1”th to “N4”th printing papers, i.e., N2 printing papers are printed while keeping the feed operation of the ink ductor roller 5 stopped. As a result, the history of ink in the ink roller group 6 is canceled, and the first ink film thickness distribution Ma is left in an appropriate amount.

In the printing unit 11-3, the “(N4−N3)+1”th to “N4”th printing papers, i.e., N3 printing papers are printed while keeping the feed operation of the ink ductor roller 5 stopped. As a result, the history of ink in the ink roller group 6 is canceled, and the first ink film thickness distribution Ma is left in an appropriate amount.

In the printing unit 11-4, the “1” st to “N4”th printing papers, i.e., N4 printing papers are printed while keeping the feed operation of the ink ductor roller 5 stopped. As a result, the history of ink in the ink roller group 6 is canceled, and the first ink film thickness distribution Ma is left in an appropriate amount.

<Ink Removing (Throw-on/off Timing Control Method for Ink Form Roller)>

In the above embodiments, in ink removing, the throw-on or throw-off timing of each of the printing units 11-1 to 11-4 is controlled. However, throw-on or throw-off of an ink form roller 6A of each of the printing units 11-1 to 11-4 may be controlled at the same timing as the throw-on or throw-off timing shown in FIG. 1 or 6.

In the above embodiments, the printing plates of the four-color printing units are simultaneously exchanged. However, the present invention can also be applied to a case wherein printing plates of two- or three-color printing units are exchanged.

As has been described above, according to the present invention, when printing plates of a plurality of printing units are exchanged, the number of printing papers to be used for ink removing is set in units of printing units which exchange the printing plates. Minimum ink necessary for printing can be left in an appropriate amount on the ink roller group of each printing unit which exchanges the printing plate. With this arrangement, an ink film thickness distribution for the next job can be accurately formed, and waste paper can be suppressed.

What is claimed is:

1. An ink film thickness control method for a multi-color printing press having a plurality of printing units for continuously performing designated color printing on a printing paper by means of ink supplied to a printing plate through an ink roller group, comprising the steps of:
when in at least two of said printing units as plate exchange printing units, exchange to new printing plates are simultaneously performed, setting the number of printing papers to be printed for ink removing in units of plate exchange printing units;
turning off an ink feed operation in each of said plate exchange printing units; and
performing printing for ink removing in each of said plate exchange printing units on the basis of the set number of printing papers while keeping the previous printing plate mounted to form a first ink film thickness distribution minimum and necessary for printing on said ink roller group of said plate exchange printing unit.

2. A method according to claim 1, further comprising the steps of:
after the first ink film thickness distribution is formed, exchanging the previous printing plate with the new printing plate in each of said plate exchange printing units; and
after the printing plate is exchanged, operating said printing press to superpose a second ink film thickness distribution corresponding to an image of the new printing plate on the first ink film thickness distribution formed on said ink roller group of said plate exchange printing unit.

3. A method according to claim 1, further comprising the steps of:
starting unit: printing in all of said plate exchange printing units in a throw-on state; and
setting said plate exchange printing units in a throw-off state in ascending order of set print counts to sequentially stop unit printing.

4. A method according to claim 3, wherein
the step of stopping unit printing comprises the steps of:
determining whether an actual print count of said plate exchange printing unit reaches the set print count in ascending order of the set print counts; and
when the actual print count reaches the set print count, individually setting said plate exchange printing unit in the throw-off state.

5. A method according to claim 1, further comprising the steps of:
setting said plate exchange printing unit in a throw-on state in descending order of set print counts to sequentially start unit printing; and
simultaneously setting all of said plate exchange printing units in a throw-off state to stop unit printing.

6. A method according to claim 5, wherein
the step of starting unit printing comprises the steps of:
determining whether a remaining print count of said plate exchange printing unit reaches the set print count in descending order of the set print counts; and
when the remaining print count reaches the set print count, individually setting said plate exchange printing unit in the throw-on state.

7. A method according to claim 1, wherein
said printing unit comprises a plurality of ink fountain keys, supplies ink in an ink fountain to an ink fountain roller by adjusting aperture ratios of said ink fountain keys, sup-plies the ink supplied to said ink fountain roller to the printing plate through said ink roller group by a feed operation of an ink ductor roller, and prints a printing paper using the ink supplied to the printing plate.

8. A method according to claim 7, further comprising the steps of:
after the first ink film thickness distribution is formed, exchanging the previous printing plate with the new printing plate in each of said plate exchange printing units;
presetting the aperture ratios of said ink fountain keys and a rotation ratio of said ink fountain roller of said plate exchange printing unit to values corresponding to an image of the new printing plate;
operating said printing press to cause said ink ductor roller of said plate exchange printing unit to perform the feed operation a predetermined number of times; and
superposing a second ink film thickness distribution corresponding to the image of the new printing plate on the first ink film thickness distribution left on said ink roller group of said plate exchange printing unit.

9. A method according to claim 1, further comprising the steps of:
designating said plate exchange printing unit from said printing units; and
selecting an ink removing mode from a plurality of modes.

10. An ink film thickness control apparatus for a multi-color printing press having a plurality of printing units for continuously performing designated color printing on a printing paper by means of ink supplied to a printing plate through an ink roller group, comprising:
setting means for, when in at least two of said printing units as plate exchange printing units, exchange to new printing plates are simultaneously performed, setting the number of printing papers to be printed for ink removing in units of plate exchange printing units;
control means for turning off an ink feed operation in each of said plate exchange printing units; and
an ink removing means for printing for ink removing in each of said plate exchange printing units on the basis of the set number of printing papers while keeping the previous printing plate mounted to form a first ink film thickness distribution minimum and necessary for printing on said ink roller group of said plate exchange printing unit.

11. An apparatus according to claim 10, further comprising
pre-inking means for, after the first ink film thickness distribution is formed, operating said printing press while keeping the new printing plate mounted to superpose a second ink film thickness distribution corresponding to an image of the new printing plate on the first ink film thickness distribution formed on said ink roller group of said plate exchange printing unit.

12. An apparatus according to claim 10, wherein
said ink removing means starts unit printing in all of said plate exchange printing units in a throw-on state and then sets said plate exchange printing units in a throw-off state in ascending order of set print counts to sequentially stop unit printing.

13. An apparatus according to claim 10, wherein
said ink removing means sets said plate exchange printing unit in a throw-on state in descending order of set print counts to sequentially start unit printing and then simultaneously sets all of said plate exchange printing units in a throw-off state to stop unit printing.
